(19) United States
(12) Patent Application Publication
(10) Pub. No.: US 2014/0317659 A1
(43) Pub. Date: Oct. 23, 2014

(54) Method and apparatus for providing interactive augmented reality information corresponding to television programs

(71) Applicant: Datangle, Inc., San Jose, CA (US)

(72) Inventor: Taizo Yasutake, Cupertino, CA (US)

(73) Assignee: Datangle, Inc., San Jose, CA (US)

(21) Appl. No.: 13/926,962

(22) Filed: Jun. 25, 2013

Related U.S. Application Data
(60) Provisional application No. 61/854,162, filed on Apr. 19, 2013.

(51) Int. Cl. H04N 21/422; H04N 21/482; H04N 21/435; H04N 21/41

(52) U.S. Cl. CPC H04N 21/42209; H04N 21/4126; H04N 21/4122; H04N 21/4828; H04N 21/435
USPC 725/43

(57) ABSTRACT

Techniques related to displaying augmented reality (AR) based multi-media content are described. The AR content is corresponding to a television (TV) program being displayed on a TV screen. One embodiment of the techniques does not need to scan any AR markers or related images to retrieve the specific AR contents. An AR system for TV broadcasting programs comprises a mobile device, a digital TV or an Internet TV set and a cloud computing based TV-AR management server. The TV-AR management server is configured to provide correct AR contents for the TV program that is being broadcasted and received in a TV set being used by a user at the time.

### CROSS-REFERENCE TO RELATED APPLICATION

This application claims the benefits of U. S. Provisional Application No.61/854,162, filed Apr. 19, 2013, and entitled “Software method to provide interactive augmented reality information corresponding to television programs”, which is hereby incorporated by reference for all purposes.

### BACKGROUND OF THE INVENTION

1. Field of the Invention

The invention is generally related to the area of augmented reality. In particular, the invention is related to techniques for overlaying corresponding augmented reality onto an image or a video being shown on a TV device.

2. The Background of Related Art

Augmented Reality (AR) is a type of virtual reality that aims to duplicate the world's environment in a computer device. An augmented reality system generates a composite view for a user that is the combination of a real scene viewed by the user and a virtual scene generated by the computer device that augments the scene with additional information. The virtual scene generated by the computer device is designed to enhance the user's sensory perception of the virtual world the user is seeing or interacting with. The goal of Augmented Reality is to create a system in which the user cannot tell the difference between the real world and the virtual augmentation of it. Today Augmented Reality is used in entertainment, military training, engineering design, robotics, manufacturing and other industries.

The recent development of mobile devices and cloud computing allows software developers to create many AR applications or programs to overlay virtual objects and/or additional 2D/3D multi-media information in a captured image. In order to display AR contents such as virtual objects in a real screen area that displays a real image, a user is required to scan AR specific markers (e.g. a QR code) or marker equivalent images to retrieve AR contents through the server.

There are some difficulties to implement AR for a television TV program. Because users usually sit in a couch to see a TV screen, it creates various issues by the distance between the TV screen and the viewers. When an AR marker is placed on a TV screen, it would create a visual difficulty to correctly detect the AR marker or a marker equivalent image that is related to the specific TV program at the time the TV program is shown. Another issue is that a TV broadcasting company might not accept to add continuous visual images in a TV program just to realize the AR function for a TV show. A TV program also has a specific difficulty for AR implementation. The time table of TV programs has an inherent problem of changeable situation in broadcasting schedule due to possible natural disasters or other emergency situations. Thus there is a need for techniques of providing interactive augmented reality content to an ongoing television program.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

In general, the present invention is related to techniques of displaying any augmented reality (AR) based multi-media information corresponding to a television (TV) program on a TV screen without scanning any AR markers or related images to retrieve specific AR contents. According to one aspect of the present invention, an AR system for TV broadcasting programs comprises a mobile device, a digital TV or an Internet TV set and a cloud computing based TV-AR management server. The TV-AR management server is configured to provide correct AR contents for the TV program that is being broadcasted and received in a TV set being used by a user at the time.

Depending on implementation, the present invention may be implemented as a method, an apparatus or part of a system. According to one embodiment, it is a method for providing augmented reality (AR) content, the method comprises: receiving a request from a mobile device to download the AR content in accordance with an image being displayed on a display screen of a TV device, where the mobile device is communicating wirelessly with the TV device to receive detailed information about the image being displayed thereon; searching appropriate AR content from a database in accordance with the detailed information about the image, wherein the appropriate AR content is in synchronized in time with the image being shown on the TV device; and releasing the appropriate AR content to the mobile device for displaying the AR content on top of the image.

According to another embodiment, it is a method for providing augmented reality (AR) content, the method comprises: sending a request from a mobile device to a server to obtain an appropriate AR content for overlaying the AR content onto an image being displayed on a display screen of a TV device, wherein the mobile device is communicating wirelessly with the TV device to receive detailed information about the image being displayed thereon; and displaying the appropriate AR content on top of the image.

One of the objects, features and advantages of the present invention is to provide a lot of flexibility in displaying corresponding AR content on an image being displayed on a TV device. The use of a mobile device is to facilitate the retrieval of correct AR content corresponding to the TV program being displayed on a TV device.

Other objects, features, benefits and advantages, together with the foregoing, are attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings where:

FIG. 1A depicts a configuration 100 according to one embodiment of the present invention;

FIG. 1B shows another embodiment in which a TV broadcasting company generates its own TV program guide or an on-air schedule in a server (referred to as updated IEPG server herein);

FIG. 1C shows a functional block diagram for the acquisition of the current TV channel from a TV set to a mobile device;

FIG. 2A depicts an illustration to show how an SLAM algorithm is used to determine the 3D coordinates of a TV frame (screen);

FIG. 2B and FIG. 2C show respectively two examples in which the AR content is displayed on the touch screen of the mobile device;

FIG. 3 shows a flowchart or process 300 of implementing in a default mode;

FIG. 4A shows a corresponding data flow 400 among different servers (as shown in FIG. 1B), where the TV-AR management server is provided for a single TV broadcasting company;

FIG. 4B and FIG. 4C depict respectively the linked database of an IEPG dataset and the AR content dataset for the TV broadcasting company to correctly identify the AR content corresponding to the TV program at the time the request is made from the mobile device;

FIG. 4D shows a system configuration in which a mobile device, a TV device (e.g., a conventional TV set or a computing device with a display screen) and a TV-AR management server for multiple TV programs offered by different TV broadcasting companies;

FIG. 5A and FIG. 5B depict respectively exemplary user interface layouts when corresponding AR information is displayed on the mobile device;

FIG. 6 shows a configuration 600 that is modified to provide the location based TV-AR content; and

FIG. 7 shows a configuration of TV-AR server to provide the statistical data of TV-AR viewers to a TV broadcasting server.

### DESCRIPTION OF THE PREFERRED EMBODIMENTS

In the following description, numerous specific details are set forth in order to provide a thorough understanding of the present invention. However, it will become obvious to those skilled in the art that the present invention may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

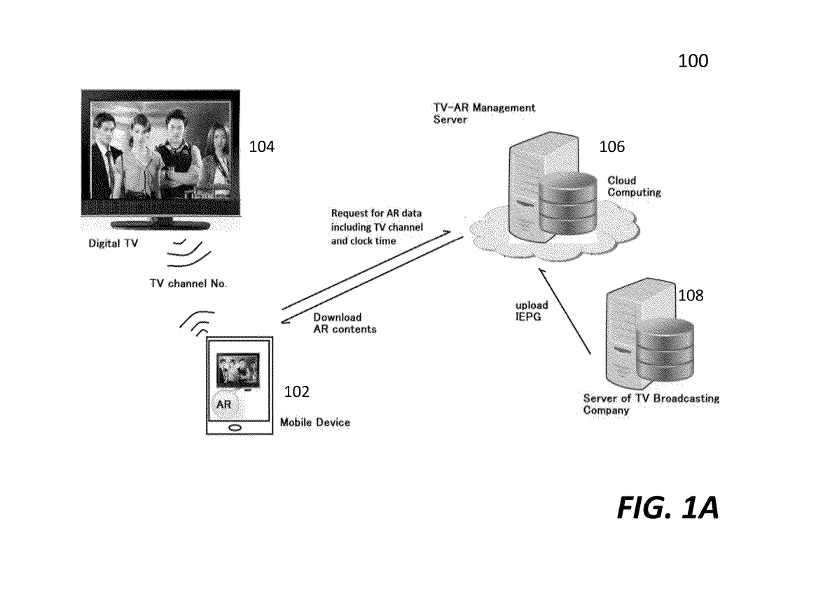

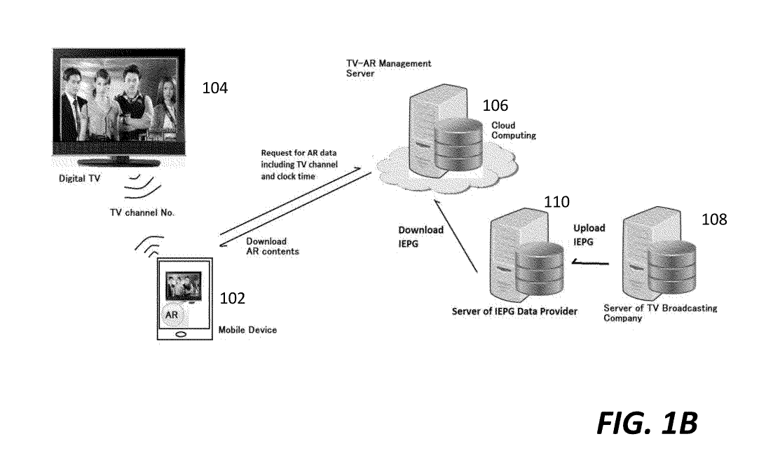

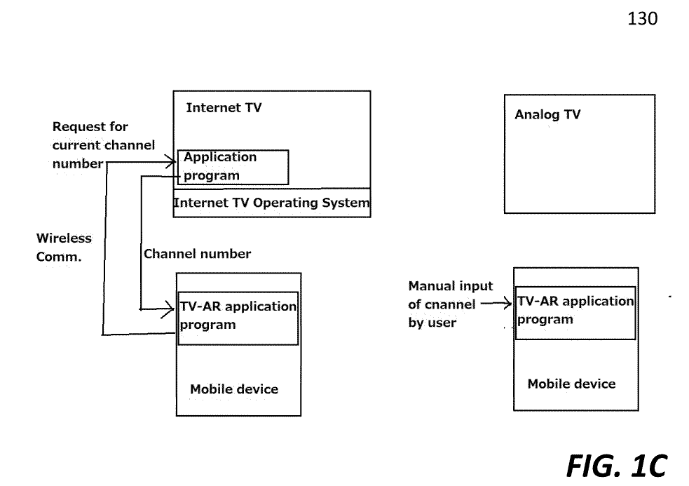

Embodiments of the present invention are discussed herein with reference to FIGS. 1-7. However, those skilled in the art will readily appreciate that the detailed description given herein with respect to these figures is for explanatory purposes as the invention extends beyond these limited embodiments.

According to one embodiment, the synchronization between a TV program guide (e.g., Internet Electronic Program Guide (IEPG)) and the built-in clock of a mobile device is utilized for the mobile device to download corresponding AR contents from a dedicated server (e.g., a cloud server), where the AR contents are exactly matched with the TV program currently being broadcast or watched by a user.

FIG. 1A depicts a configuration 100 according to one embodiment of the present invention. A mobile device 102 communicates with a digital TV set 104 or the operating system of Internet TV set (e.g., Google Android operating system) to identify a TV channel currently being shown through WiFi Direct or other wireless communication such as Bluetooth protocol. For example, Wi-Fi Direct, previously known as Wi-Fi P2P, is a standard that allows Wi-Fi devices to connect to each other without the need for a wireless access point. This allows Wi-Fi Direct devices to directly transfer data between each other with greatly reduced setup. The setup generally includes bringing two Wi-Fi Direct devices together and then triggering a pairing or coupling procedure between them, for example, using a button on one of the devices. When a device enters the range of the Wi-Fi Direct host, they can communicate to each other using the existing ad-hoc protocol.

The mobile device 102 is caused to communicate with a cloud server 106 to retrieve AR content corresponding to the program being shown in the channel. The cloud server 106 is figured to be coupled to a server 108 (referred to as an IEPG server herein) providing the IEPG or the TV program currently being selected and viewed on the TV set 104. As shown in FIG. 1A, the mobile device 102 is caused to execute an application that is configured to send a request to the cloud server 106 to retrieve the corresponding AR content. The request includes data about what TV channel is being shown. To provide timely synchronized AR content corresponding to the TV program being shown in the TV set 104, the cloud server 106 executes a module configured to communicate with the server 108 to obtain synchronization information so as to retrieve the corresponding AR content for the mobile device 102 to download. The downloaded or down-streamed AR content can be displayed in the mobile device 102, namely to overlay the AR content onto an image from the TV program being shown.

According to one embodiment as shown in FIG. 1B, a TV broadcasting company generates its own TV program guide or an on-air schedule in a server 110 (referred to as updated IEPG server herein). This IEPG dataset in the server 110 is continuously updated and uploaded to the TV-AR management server 106. The raw data of original IEPG could be provided by (i) direct uploading from a TV broadcasting server 108, (ii) the TV broadcasting company subsidized server or the IEPG data provider.

FIG. 1B depicts the multiple server configuration including the TV-AR management server 106, the server 110 of IEPG data provider and the server 108 of TV broadcasting company. Those skilled in the art can understand and appreciate that these servers 106, 106 and 110 may not be necessarily separately operated. Depending on implementation, some of the servers can be implemented in one server while one of the servers may not be physically alone as it may be implemented as a distribution system. In any case, to facilitate the description of the present invention, these servers are described as if they are independently operated and controlled by one or different entities.

According to one embodiment, a software module or program is developed and executed in the TV-AR management server 106. The module is configured to acquire the IEPG data from the server 108 run by the TV broadcasting company. In one embodiment, the IEPG data is in XMLTV maintained by XMLTV project, where XMLTV is an open source and very popular XML based file format for describing TV program listings. XMLTV is also an interface software between programs that emit guide data and programs that consume it. XMLTV consists of the collection of software tools to obtain, manipulate, and search updated TV program listings.

In one embodiment, the TV-AR management server 106 is designed to have several Comma Separated Values (CSV) files in its server environment to contain descriptions of each TV channel program. The attributes for the IEPG dataset corresponding to each TV channel shall have at least the following information:

Date and time of day when the TV program will start.

Duration or total running time for the described program.

Title that the program should show for described program.

Description that the program should show during on-air time.

The number of attributes for IEPG could be increased, depending on the application of AR contents and the timing of the display on the mobile device. FIG. 1C shows a functional block diagram 130 for the acquisition of the current TV channel from a TV set to a mobile device. In case of an Internet TV shown on the left side of FIG. 1C, the application software is developed for the Internet TV operating system (e.g., Google Android Operating System) to receive the data request of the current TV channel from the mobile device and to send the TV channel number to the mobile device through a wireless link. In case of a conventional analog TV set, it is usually not easy to install the above application software in the analog TV environment. This problem could be overcome by the provision of user interface layout in the TV-AR application program at the mobile device side to allow the user to manually input the current TV channel.

In operation, a mobile device is caused to send a request with data including the current time and the TV channel to the TV-AR management server in a cloud computing network. In return, the mobile device downloads the AR contents corresponding to the TV program. The TV broadcasting station server uploads continuously the updated TV program dataset to the TV-AR management server through the Internet. If the mobile device successfully downloads the correct AR content for the TV program, then an image processing application is executed to determine the local 3D coordinates of the TV frame by using the video camera of the mobile device. Once the local coordinates of TV frame are determined, the mobile device displays the AR contents to fit into the currently captured video view including the TV screen frame.

The TV broadcasting company that performs terrestrial/cable/satellite digital TV broadcasting could provide its own IEPG data. The IEPG has an adaptive function to adjust a sudden change of the original TV program schedule by some incidents, such as emergency news or natural disasters, the IEPG provides adaptive functions to update the time table of the TV program by (1) receiving an alert notice from the TV company and displaying it on the smart phone (2) updating the a rescheduled TV time table. The IEPG data includes program descriptions, transmission schedules (start time and finish time), flags to indicate the state thereof.

The TV broadcasting company continuously updates its TV program schedule and uploads the IEPG data to the TV-AR management server. The TV-AR management server identifies the correct AR contents corresponding to the TV program at the time. The mobile device downloads the AR content selected by the TV-AR management server. After the AR content is successfully downloaded to the mobile device, the mobile device overlays the AR content on a camera captured image being displayed on the screen of the mobile device.

By utilizing the IEPG for digital TV broadcasting, the AR content management located on a cloud computing server is an entirely new approach to display a broad array of AR contents. Because the identification of correct AR contents does not require any conventional image processing method such as conventional markers (e.g. black and white rectangle image), QR codes or other image pieces that is used to retrieve the correct AR contents from the cloud server.

According to one embodiment, an image processing algorithm is designed to determine the local 3D coordinates of a visually identified 3D object in the reference 3D coordinates (i.e., world coordinates). The image processing algorithm is referred to as the simultaneous location and mapping (SLAM) algorithm which is a well known image processing method in the field of computer vision to resolve the problem of building a 3D map while at the same time localizing the mobile camera within that map. The purpose is to eventually obtain the 3D coordinates of captured 3D object (e.g., a TV frame) in a camera view. The SLAM based TV frame tracking algorithm creates a point cloud of (3D map) of distinctive object features in the camera scene including the TV frame and determines the local 3D coordinates of the TV frame. It is also beneficial for the SLAM algorithm to provide the prior knowledge about the size of TV frame (e.g. the actual size of the TV display screen) for efficient initialization of the SLAM based 3D tracking.

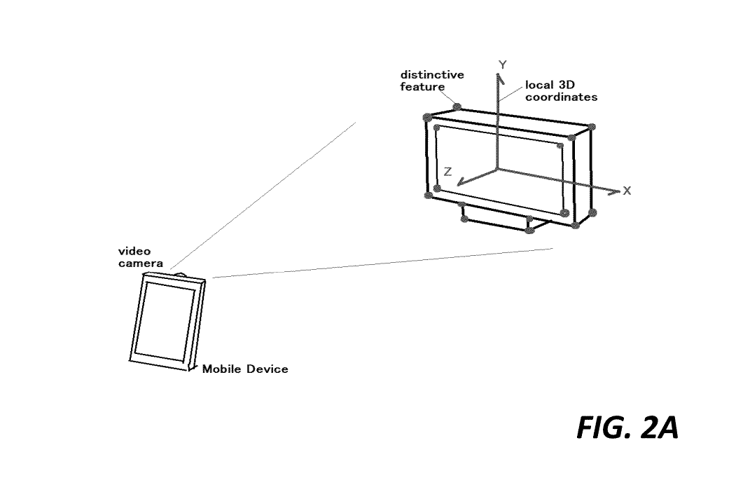

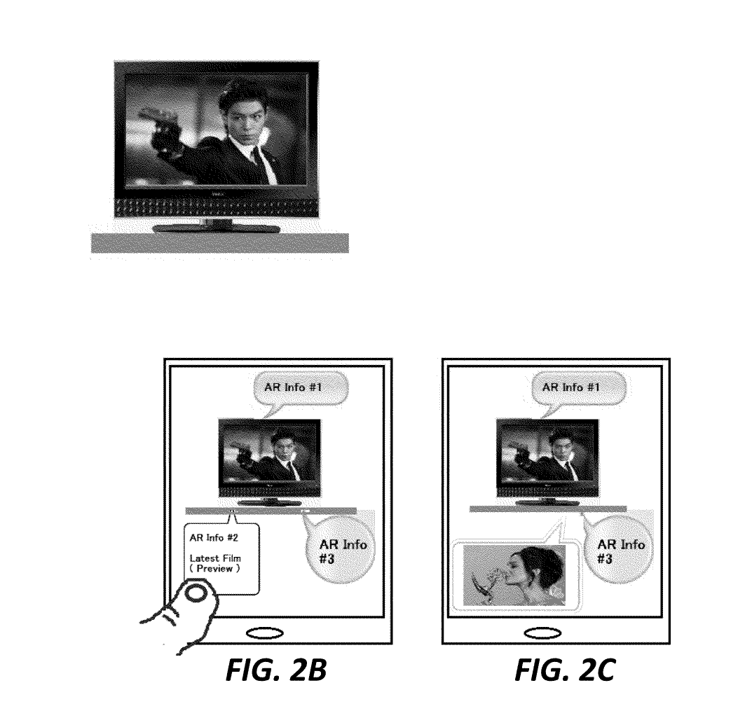

According to one embodiment, FIG. 2A depicts an illustration to show how an SLAM algorithm is used to determine the 3D coordinates of a TV frame. In operation, the video camera of mobile device continuously captures the TV frame in 3D environment. The SLAM algorithm based image processing application program in the mobile device detects distinctive object features of the TV frame such as sharp corners and/or long edges to develop the 3D map of distinctive point data set. Based on those points with prior knowledge of the TV size (e.g. 40-inch TV screen), the SLAM algorithm computes the local 3D coordinates of the TV frame in the reference 3D coordinates. As a result, the AR content can be properly displayed on the display screen of the mobile device in accordance with the local 3D coordinates of the TV frame.

FIG. 2B and FIG. 2C show respectively two examples in which the AR content is displayed on the touch screen of the mobile device. FIG. 2B shows that there are three text-based AR contents displayed corresponding to the TV program being shown. When a user touches the “information rectangle” at the lower left area, the video clip starts for additional AR contents shown in FIG. 2C.

According to one embodiment, there are optional modes for displaying the AR contents.

The default mode, or Display Mode 1 of AR contents may be implemented as functional steps as follows:
STEP 1: The mobile device sends a request for AR content including the current TV channel and the clock time, then it acquires the AR information by downloading it from the TV-AR server.
STEP 2: If the mobile device successfully determines the coordinates of the TV frame by the image from the video camera thereof, the display of AR content shall start and continuously update it corresponding to the current time.
STEP 3: If the video camera lost the TV frame from the video, then the AR content will disappear from the video captured screen. If the video camera could re-capture the TV frame, the AR content shall show up again.

The optional mode or Display Mode 2 of the AR content shall start after successful image capture of the TV frame by the video camera at beginning. Once the AR content is displayed, the user does not have to continuously capture the TV frame to maintain the display of AR content. The AR content is kept on displaying and updated without the image capture of the TV frame by the video camera.

The other optional mode or Display Mode 3 of the AR contents shall independently be displayed without the image capture of the TV frame. When the mobile device completes the download of the AR content, then the AR content shall be displayed on the screen of the mobile device regardless of the currently captured image status of the video camera.

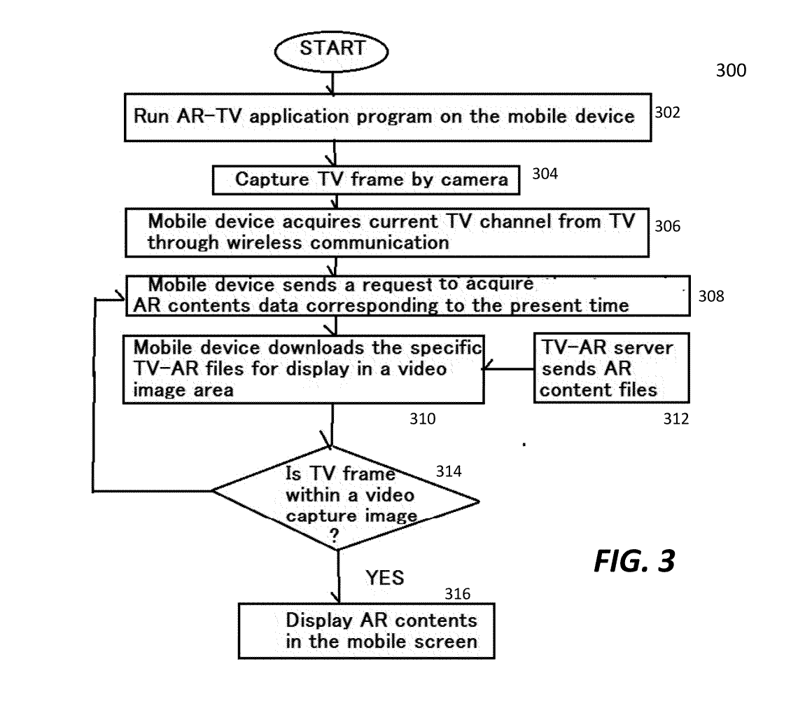

FIG. 3 shows a flowchart or process 300 of implementing in the default mode. The process 300 is preferably implemented in software but can also be implemented in combination of software and hardware. At 302, a user starts the TV-AR application program. Depending on implementation, such an application may be a downloadable application or provided on a website. In one embodiment, the application is configured to cause the mobile device to turn on the camera thereof. The camera captures the TV set (i.e., the display screen) at 304 using the camera in his mobile device. At 306, the mobile device further acquires a currently selected TV channel through the wireless communication with the TV set. This wireless communication could be realized by Wi-Fi, WiFi Direct or Bluetooth. Then, the TV-AR application program activates a specific AR-TV function corresponding to the TV channel data sent from the TV set. The mobile device sends a request including the TV channel and current clock time to the TV-AR management server for downloading the appropriate AR content related to the selected TV channel. The TV-AR management server provides the correct AR contents to respond to the request from the mobile device. Once the downloading of the AR content is completed, the mobile device displays the AR content if the TV frame is still within a camera view area.

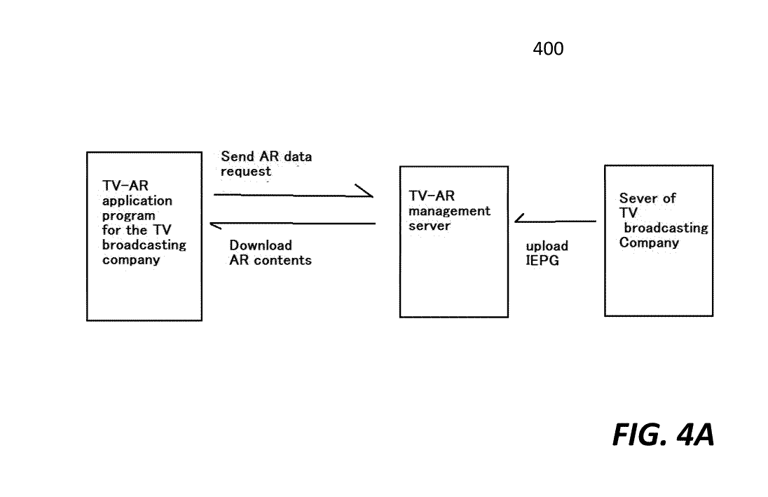

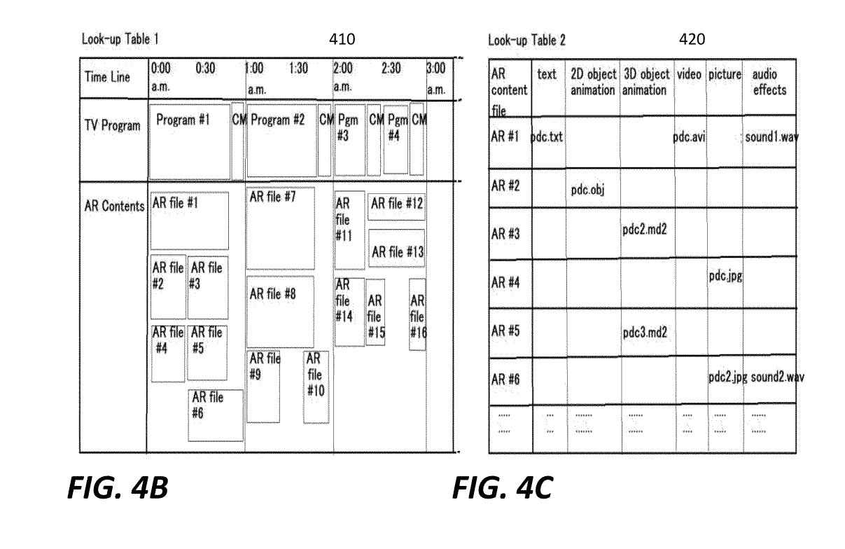

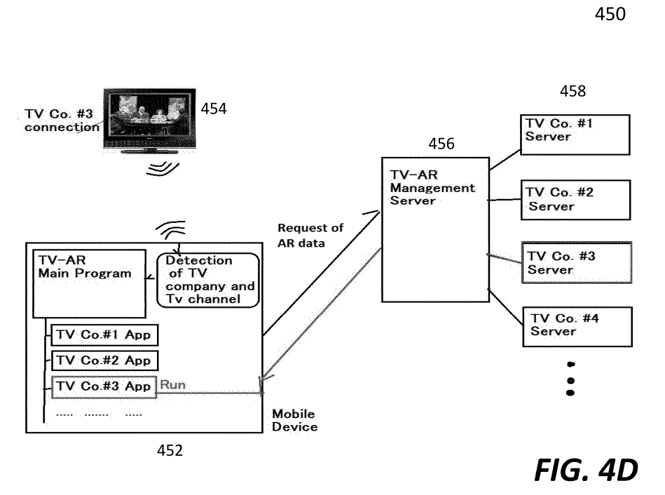

FIG. 4A shows a corresponding data flow 400 among different servers (as shown in FIG. 1B), where the TV-AR management server is provided for a single TV broadcasting company. The TV broadcasting company continuously uploads the updated IEPG data packets to the TV-AR management server through the Internet. The TV-AR management server maintains a database to manage the provision of correct AR contents depending on the timeline of the TV channel provided by the TV broadcasting company. The mobile device installs a specific TV-AR application program that could download the AR contents for the specified TV broadcasting company.

FIG. 4B and FIG. 4C depict respectively the linked database 410 of an IEPG dataset and the AR content dataset 420 for the TV broadcasting company to correctly identify the AR content corresponding to the TV program at the time the request is made from the mobile device. As shown in FIG. 4B and FIG. 4C, there are two look-up tables to correctly retrieve the TV program on a time line and the specified AR contents corresponding to the present time acknowledged by the built-in clock of mobile device. FIG. 4B shows the lookup table 410 of the IEPG and AR contents. FIG. 4C shows the look-up table 420 to select necessary AR files for preparation of downloading to the mobile device.

FIG. 4D shows a system configuration 450 in which a mobile device 452, a TV device 454 (e.g., a conventional TV set or a computing device with a display screen) and a TV-AR management server 456 for multiple TV programs offered by different TV broadcasting companies. The description above for a single TV broadcasting company can be extended to the situation in which there are multiple TV broadcasting companies independently providing their own AR contents for their TV programs. The TV broadcasting companies include, but shall not be limited to, terrestrial TV broadcasting companies, cable TV companies, Internet TV companies and satellite TV companies. Similarly, a TV-AR application program installed in the mobile device is executed to identify which TV company occupies the TV set 454 through the wireless communication with the operation system of the TV set 454. Then, the mobile device 452 activates a specific TV-AR application module only usable for the TV broadcasting company that currently occupies the TV set 454. Then, the mobile device downloads the correct AR content from the TV-AR management server 456 through Internet connection, where the server 456 is configured to retrieve the corresponding AR content from a designated server (one of the providers 458).

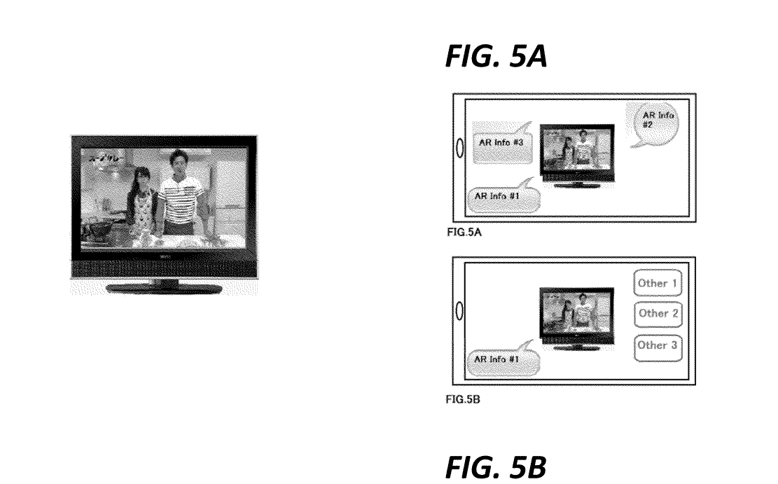

FIG. 5A and FIG. 5B depict respectively exemplary user interface layouts when corresponding AR information is displayed on the mobile device. In FIG. 5A, the AR content is displayed corresponding to the time line. The display of the AR content starts and is kept on displaying and disappears according to the specifications of a AR time-line defined by the database in the TV-AR management server.

FIG. 5B, the primary AR content is directly displayed on the screen of mobile device and disappears according to the specifications of AR time-line. However, the user can display other AR information by selecting AR menu at right side of the screen.

According to one embodiment, the content of a TV program by a TV broadcasting company may vary from one location to another. Therefore, without one embodiment of the present invention, a user would receive correct AR content at one location, but may receive incorrect AR content at another location.

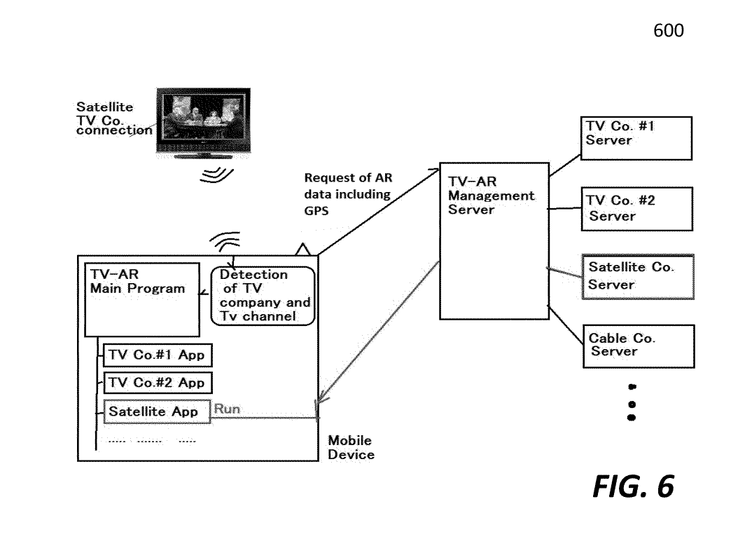

FIG. 6 shows a configuration 600 that is modified to provide the location based TV-AR content. According to one embodiment, the mobile device sends its location data (e.g., GPS data), the TV channel and current clock time to the TV-AR management server by wireless Internet connection. The TV-AR management server searches the correct IEPG data that is corresponding to the specified location. Then, the TV-AR server sends the correct AR information data set of the current TV program in the TV set in proximity of the mobile device.

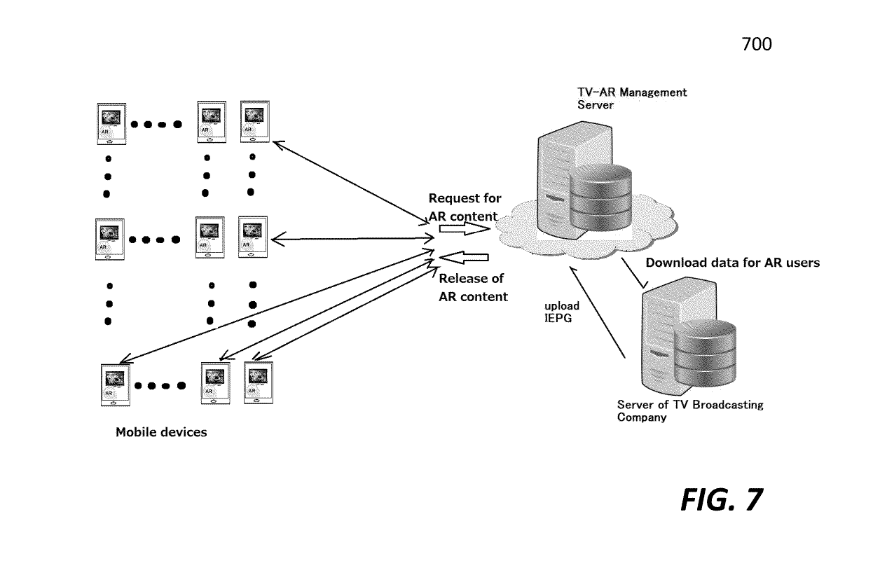

FIG. 7 shows an exemplary configuration of a TV-AR server that is configured to provide the statistical data of TV viewers that have watched the AR content released from the TV-AR server. The TV-AR server is configured to receive the requests from many mobile devices in various geographic locations. Those requests including GPS data of individual mobile devices could be utilized as feedback information to an AR content provider or a TV broadcasting company. According to one embodiment, the TV-AR server is designed to classify the requests from these mobile devices for the statistical analysis of TV viewers who utilize the AR content. The statistical data analysis includes at least (i) a total number of TV viewers who have currently activated a service to receive the AR application, (ii) the total number of viewers of (i) within a time window, such as hourly, daily, weekly or monthly basis, (iii) a total number of viewers who interactively use an AR interface to obtain further detailed AR content, (iv) how long each viewer has watched the specific AR contents of a specific TV channel, (v) a geological distribution of the viewers. The statistical analysis could be beneficial for the AR content provider or a TV broadcasting company to evaluate the effectiveness of the AR content for a predefined purpose, e.g., commercial advertisement, notification of critical information to general public or other purposes.

The invention is preferably implemented in software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The processes, sequences or steps and features discussed above are related to each other and each is believed independently novel in the art. The disclosed processes and sequences may be performed alone or in any combination to provide a novel and unobvious system or a portion of a system. It should be understood that the processes and sequences in combination yield an equally independently novel combination as well, even if combined in their broadest sense; i.e. with less than the specific manner in which each of the processes or sequences has been reduced to practice.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

I claim:

1. A method for providing augmented reality (AR) content, the method comprising:
receiving a request in a server from a mobile device to download the AR content in accordance with an image being displayed on a display screen of a TV device, wherein the mobile device is communicating wirelessly with the TV device to receive detailed information about the image being displayed on the TV device;
searching the AR content from a database in accordance with the detailed information about the image, wherein the AR content is in synchronized in time with the image being shown on the TV device; and
releasing the AR content to the mobile device for displaying the AR content on top of the image in the mobile device.

2. The method as recited in claim 1, wherein the TV device is selected from a group consists of a television set and a computing device with a display screen.

3. The method as recited in claim 1, wherein the TV device is equipped with a wireless communication capability to communicate with the mobile device to release the detailed information to the mobile device.

4. The method as recited in claim 1, wherein the detailed information includes at least a channel of a video including the image.

5. The method as recited in claim 4, wherein the request includes the detailed information along with a local time of the image to facilitate the searching of the AR content in a server in reference to an Internet Electronic Program Guide (IEPG).

6. The method as recited in claim 5, wherein the server is configured to update the IEPG provided by at least one TV program company.

7. The method as recited in claim 6, wherein the AR content being displayed on the mobile device includes an interactive menu to further display additional content when the menu is activated.

8. The method as recited in claim 7, wherein the additional content includes multimedia content.

9. The method as recited in claim 4, wherein the request includes GPS data to indicate a geographic location of the mobile device, the detailed information along with a local time the image is being shown to facilitate the searching of the AR content in a server in reference to an Internet Electronic Program Guide (IEPG).

10. The method as recited in claim 9, wherein the server is configured to obtain the AR content intended for the geographic location.

11. The method as recited in claim 1, wherein said releasing the AR content to the mobile device for displaying the AR content on top of the image in the mobile device comprises:
obtaining the image; and
overlaying the AR content to the image according to a determined location of the image.

12. The method as recited in claim 11, wherein the determined location of the image is calculated by the mobile device.

13. The method as recited in claim 11, wherein the determined location of the (video) image is calculated by using a video camera of the mobile device to take images of a display screen of the TV device, and wherein the mobile device is caused to execute a software module to determine 3D coordinates of the display screen for overlaying the AR content according to the 3D coordinates onto the image being shown on the display screen.

14. The method as recited in claim 1, wherein the server is configured to collect statistic data about users that have accessed the AR content, the statistic data is based on one of time, geographic locations and a specific channel.

15. A method for providing augmented reality (AR) content, the method comprising:
sending a request from a mobile device to a server to obtain the AR content for overlaying the AR content onto an image being displayed on a display screen of a TV device, wherein the mobile device is communicating wirelessly with the TV device to receive detailed information about the image being displayed on the TV device;
retrieving the AR content from the server, wherein the server is configured to search the AR content from a database in synchronization with a time included in the request; and
displaying the AR content on top of the image in the mobile device.

16. The method as recited in claim 15, wherein the TV device is equipped with a wireless communication capability to communicate with the mobile device to release the detailed information to the mobile device.

17. The method as recited in claim 15, wherein the detailed information includes at least a channel of the image.

18. The method as recited in claim 15, wherein the request includes the detailed information along with a local time of the image to facilitate the searching of the appropriate AR content in a server in reference to an Internet Electronic Program Guide (IEPG).

19. The method as recited in claim 18, wherein the server is configured to update the IEPG provided by at least one TV program company.

20. The method as recited in claim 19, wherein the AR content being displayed includes an interactive menu to further display additional content when the menu is activated.

21. The method as recited in claim 20, wherein the additional content includes multimedia content.

22. The method as recited in claim 17, wherein the request includes GPS data to indicate a geographic location of the mobile device, the detailed information along with a local time of the image to facilitate the searching of the appropriate AR content in the server in reference to an Internet Electronic Program Guide (IEPG).

23. The method as recited in claim 22, wherein the server is configured to obtain the appropriate AR content intended for the geographic location.
